(19) United States
(12) Patent Application Publication
(10) Pub. No.: US 2010/0018172 A1
(43) Pub. Date: Jan. 28, 2010

(54) Horse protector

(75) Inventor: Ju-Sung Chang, Nantou County (TW)

Correspondence Address: Ju-Sung Chang, P.O. Box 44-2049, Taipei, 10668, TW

(73) Assignee: Jone-Shou Industrial Co., Ltd.

(21) Appl. No.: 12/219,464

(22) Filed: Jul. 23, 2008

(51) Int. Cl. A01K 13/00; B68C 5/00

(52) U.S. Cl. 54/82; 119/850

(57) ABSTRACT

A horse protector may be a horse hoof protector or a leg protector and includes a body formed of a plastic material by way of injection molding. A surface element, such as leather, is disposed at a predetermined position of injection. Thus, when the body is being formed by way of injection molding, the surface element is integrally adhered to the outer surface of the body. Thus, the protector has the simple structure and can be easily manufactured, and the surface element of the protector is firmly bonded and is free from detachment.

### BACKGROUND OF THE INVENTION

(1) Field of the Invention

The invention relates to a protector product for a leg or a hoof of a horse in an activity or an entertainment equestrian activity.

(2) Description of the Prior Art

Various equestrian games and activities are popular in the world, or even special equestrian schools are established in various countries, such as Spain or Britain, to train horses with pure bloods and trainers. Nevertheless, the horse riding activity can soothe the souls of children and adolescents and provide the body-building effect, and also provide positive effects to the cerebral palsy patients. Thus, the horse riding activity is getting more and more popularized and can be approved and accepted by more persons. There are many kinds of equestrian tools to be mounted on the horse. This is because that the equestrian activity can provide the body-building effect, and the value of taking care of the horse has gradually become as higher as that of taking care of the pet. Thus, the saddle, the protecting clothes, the protector for the horse's feet or even the horsetail holder is continuously updated.

In order to make the equestrian performance activity become more attractive and to properly protect the leg and the hoof of the horse, a conventional hoof protector is provided, as shown in FIGS. 8 and 9. A hoof protector 70 is a C-shaped ring for enclosing the overall side surface of the hoof of the horse. The C-shaped ring has two ends at its opening, and a fastener tool 78 in the form of a hook fastener including a male fastener and a female fastener is sewed to the two ends. The detailed structure of the hoof protector 70 will be described in the following. A C-shaped filler 71 made of a foaming material, such as sponge, is formed. A projection 72 corresponding to the hoof of the horse is formed in the depression at the middle of the filler 71 to mesh with the depression of the hoof of the horse. An upper edge of the filler 71 also has a ring of filler 73. Thus, an inner layer 74, such as cloth, is adhered to and covers the inner surface of the filler 71 and the filler 73. Then, an outer decorative layer 75 made of cloth or leather covers and is sewed to the inner layer 74 so that the inner layer 74 and the outer decorative layer 75 respectively cover the inner and outer side surfaces of the filler 71. The fastener tool 78 is sewed to the outer sides of the outer decorative layer 75 at two ends of the hoof protector 70 so that the hoof protector 70 encloses the ring surface of the hoof of the horse. The fastener tool 78 may work so that the hoof protector 70 provides the function of protecting the hoof of the horse.

However, the hoof protector has the complicated structure and the manufacturing processes of the hoof protector are very complicated. The processes of adhering the inner layer 74 and the outer decorative layer 75 to the filler 71 and the filler 73 and covering the filler 71 and the filler 73 with the inner layer 74 and the outer decorative layer 75, and the processes of sewing the inner layer 74 and the outer decorative layer 75 lengthen the production time of the hoof protector 70 and increase the cost of the hoof protector 70. In addition, the number of elements is very great, the filler 71 and the filler 73 have to be shaped, and the inner layer 74 and the outer decorative layer 75 are made of different materials so that the manufacturing processes are complicated. Under the global trends of energy saving and carbon reduction, it is an important subject to provide a glory horse protector that can be easily manufactured and has the low cost.

### SUMMARY OF THE INVENTION

It is therefore a main object of the invention to provide a horse protector, such as a hoof protector or a leg protector, wherein when a single-layered body is being shaped or molded, it is integrally combined with a surface element made of the leather material, for example, so that the glory horse protector has the low cost and the simple structure and can be easily and rapidly manufactured.

The invention achieves the above-identified object by providing a horse protector, which may be a hoof protector or a leg protector.

The hoof protector is a C-shaped horse hoof ring. A fastener tool is combined with a C-shaped opening. The main feature is that the hoof protector includes a C-shaped horse hoof-like body made of a plastic material. An annular surface around the body defines a base. An inner surface of the base is formed with a projection corresponding to a depression of a hoof of a horse. A top edge of the base is an outward projecting and annular top edge portion. The hoof protector includes a surface element, which is adhered to the base as the body is formed, wherein the surface element is adhered to an outer surface of the base other than the projection.

The horse protector is a leg protector having two ends combined with a fastener tool. The main feature is that the leg protector includes a body formed of a plastic material. The leg protector includes a surface element adhered to an outer surface as the body is formed.

According to the technological means of the invention, the effects of the invention can be obtained and listed in the following.

First, the invention solves the prior art problems of the horse protector because the prior art manufacturing processes are complicated and the manufacturing cost is high. The body containing the projection is formed by the plastic material, and the surface element is placed at the predetermined position during the material injecting procedure to ensure that the body and the surface element are integrally combined together. Thus, the body can be combined with the surface element in one process. So, the invention is free from the complicated and repeated sewing processes of three layers so that the manufacturing cost can be reduced and the processing time can be shortened.

Second, the body and the surface element are combined firmly and in close contact with each other so that the invention is free from the problem of detachment. Unlike the conventional structure, in which the sewing wire tends to be peeled off so that the structure combination become poor and the exterior defects appear, the invention makes the fixing property of the surface element become more reliable and practical.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial exterior view showing a hoof protector according to a preferred embodiment of the invention.

FIG. 2 is a cross-sectional side view showing the hoof protector according to the preferred embodiment of the invention.

FIG. 3 is a first pictorial view showing a fastening operation of the hoof protector according to the preferred embodiment of the invention.

FIG. 4 is a second pictorial view showing the fastening operation of the hoof protector according to the preferred embodiment of the invention.

FIG. 5 is a third pictorial view showing the fastening operation of the hoof protector according to the preferred embodiment of the invention.

FIG. 6 is a pictorial exterior view showing a leg protector according to a preferred embodiment of the invention.

FIG. 7 is a cross-sectional side view showing the leg protector according to the preferred embodiment of the invention.

FIG. 8 is a pictorial exterior view showing a conventional hoof protector.

FIG. 9 is a cross-sectional side view showing a conventional leg protector.

### DETAILED DESCRIPTION OF THE PREFERRED EMBODIMENTS

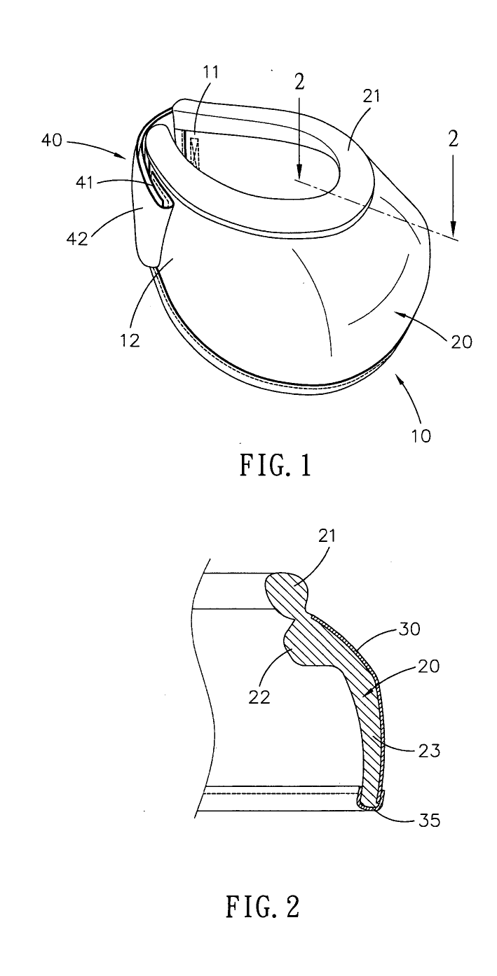

The invention provides a horse protector, such as a hoof protector or a leg protector. FIG. 1 shows a hoof protector 10 according to a preferred embodiment of the invention. The hoof protector 10 of the invention includes a body 20 and a surface element 30, which are integrally combined together.

As shown in FIGS. 1 to 3, when the hoof protector 10 is to be manufactured, a mold is prepared. The mold is configured such that the C-shaped horse hoof-like body 20 is formed when a plastic material is injected into the mold. The body 20 has a first end 11 and a second end 12 formed at the C-shaped opening. An annular surface around the body 20 defines a base 23. A projection 22 corresponding to a depression of the hoof of the horse is still formed at the middle of the inner surface of the base 23, and a top edge of the base 23 is an outward projecting and annular top edge portion 21.

The surface element 30 matching with the outer surface curvature and the dimensions of the body 20 is cut in advance, wherein the surface element 30 may be made of the leather or synthesis leather or cloth material.

The mold is designed to let the surface element 30 be placed at a setting position such that the surface element 30 corresponds to the overall outer annular surface of the base 23 of the body 20 but may not be distributed within the range of the top edge portion 21. When the plastic material is injected into the mold to form the body 20 including the base 23, the top edge portion 21 and the projection 22, the projection 22 corresponds to the depression of the hoof of the horse to ensure that the hoof protector 10 can be worn comfortably and to avoid the possibility of left and right loosening of the hoof protector 10. After the body 20 is cured and shaped, the surface element 30 is embedded into the body 20 and fully and tightly adhered to the body 20 so that the surface element 30 and the body 20 are integrally combined together. More particularly, the surface element 30 and the body 20 are formed at a time, so the technology of the invention is different from the prior art, in which the repeated sewing processes have to be performed for combination.

After the surface element 30 is combined with the body 20, a protection side 35 may be sewed to the bottom side of the base 23 other than the top edge portion 21 according to the decorative property and the edge protection requirement.

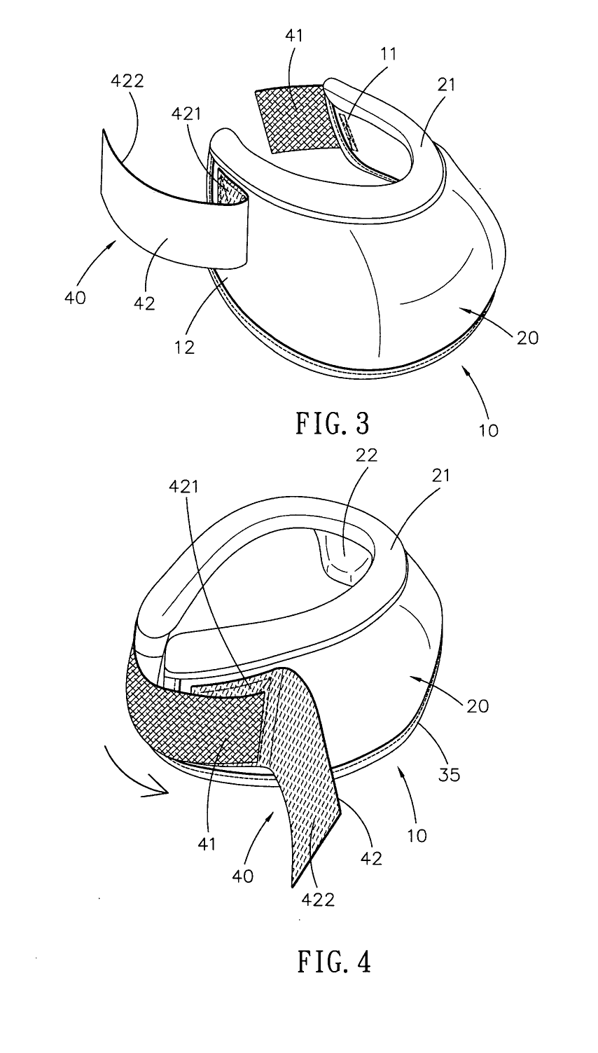

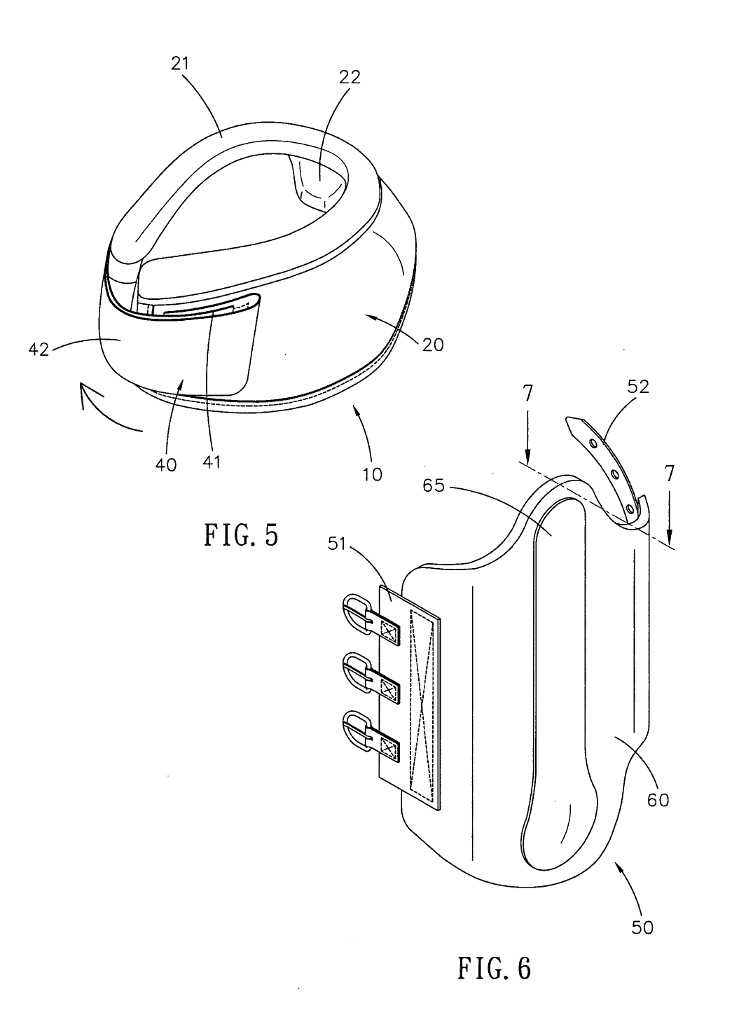

Next, as shown in FIGS. 3 to 5, a fastener tool 40 is disposed on the first end 11 and the second end 12, wherein illustrations thereof are simplified because the technique is well known in the art. The fastener tool 40 is a hook fastener having a first fastener tool 41 and a second fastener tool 42. One end of the first fastener tool 41 is sewed to the first end 11 of the body 20, while the second fastener tool 42 is sewed to the second end 12. The second fastener tool 42 has a first adhesive surface 421 and a second adhesive surface 422. After the first fastener tool 41 surrounds and is adhered to the first adhesive surface 421, the second adhesive surface 422 is again reversely fastened to the outer surface of the first fastener tool 41. Thus, the use of the fastener tool 40 can make the hoof protector 10 be positioned and enclosed around the hoof of the horse.

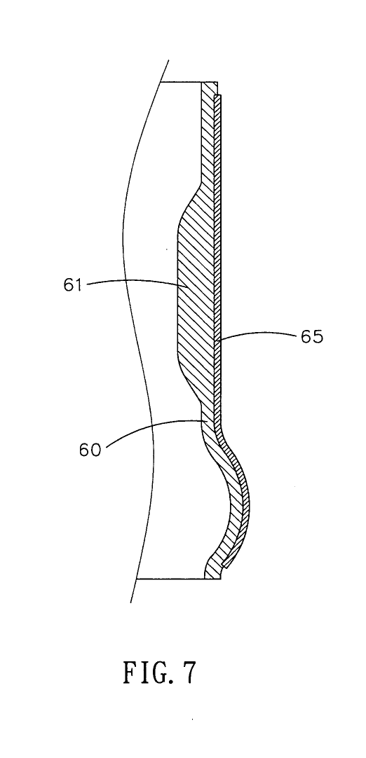

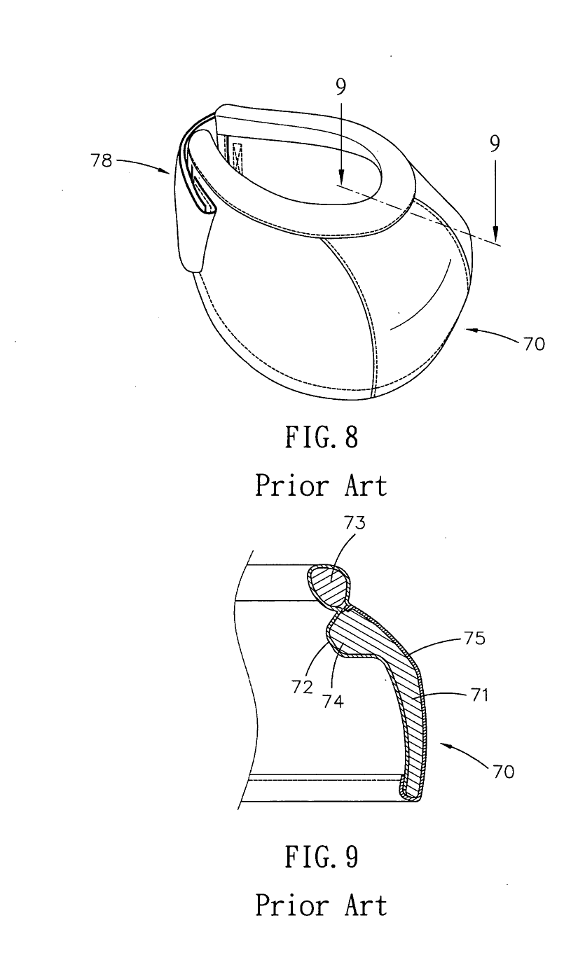

As shown in FIGS. 6 and 7, a leg protector 50 of this embodiment is adopted to enclose the lower leg above the hoof of the horse. The basic structure of the leg protector 50 includes a body 60 having one end sewed to a first fastener tool 51, and the other end connected to a second fastener tool 52. The first and second fastener tools 51 and 52 are in the forms of belts and belt connectors. The feature of the invention is that a mold is pre-formed to shape the body 20. The middle of the inner surface of the body 20 facing the leg of the horse is still formed with a projection 61, which corresponds to the depression of the leg of the horse and functions in a manner similar to that of the projection of the hoof protector. Thus, a surface element 65 made of leather is cut in advance and is placed at a setting position of the mold. When the plastic material is injected into the mold to form the body 60, the surface element 65 is integrally adhered to the outer surface of the body 60 other than the projection 61. Patterns, trademarks or texts may be printed on the surface element 65.

Consequently, either the hoof protector 10 or the leg protector 50 may be manufactured in one manufacturing process so that the manufacturing cost can be greatly reduced and the manufacturing processes can be simplified.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A horse protector being a hoof protector having a C-shaped ring, wherein a fastener tool is combined with a C-shaped opening of the hoof protector, and the characteristic lies in that:
the hoof protector comprises a C-shaped horse hoof-like body made of a plastic material, an annular surface around the body defines a base, an inner surface of the base is formed with a projection corresponding to a depression of a hoof of a horse, and a top edge of the base is an outward projecting and annular top edge portion; and
the hoof protector comprises a surface element, which is adhered to the base as the body is formed, wherein the surface element is adhered to an outer surface of the base other than the projection.

2. The horse protector according to claim 1, wherein the fastener tool is a hook fastener.

3. A horse protector being a leg protector having two ends combined with a fastener tool, wherein the characteristic lies in that:
the leg protector comprises a body formed of a plastic material; and
the leg protector comprises a surface element adhered to an outer surface as the body is formed.

4. The horse protector according to claim 3, wherein the fastener tool is a hook fastener.

5. The horse protector according to claim 3, wherein the surface element is disposed at a local position of the body.
